(19) United States
(12) Patent Application Publication
(10) Pub. No.: US 2025/0130564 A1
(43) Pub. Date: Apr. 24, 2025

(54) Computer Vision Systems and Methods for Determining Roof Age and Remaining Life

(71) Applicant: Insurance Services Office, Inc., Jersey City, NJ (US)

(72) Inventors: Antonio Godino Cobo, South Jordan, UT (US); Ryan D'Amario, Tampa, FL (US)

(73) Assignee: Insurance Services Office, Inc., Jersey City, NJ (US)

(21) Appl. No.: 18/919,608

(22) Filed: Oct. 18, 2024

Related U.S. Application Data
(60) Provisional application No. 63/544,809, filed on Oct. 19, 2023.

(51) Int. Cl. G05B 23/02; G06V 20/10

(52) U.S. Cl. CPC G05B 23/0283; G06V 20/176

(57) ABSTRACT

Computer vision systems and methods for determining roof age and life are provided. The system processes newer and older images of an area of interest that includes a structure having a roof using computer vision to detect changes in roof conditions over time, and calculates a ground truth model of roof age and roof condition based on the detected changes. An initial linear regression model is calculated by the system, and noise is filtered from the model. A final linear regression model is then calculated by the system and validated. Using the final linear regression model, the system determines an age of the roof in the area of interest as well as the remaining life of the roof.

### RELATED APPLICATIONS

This application claims priority to U.S. Provisional Patent Application Ser. No. 63/544,809 filed on Oct. 19, 2023, the entire disclosure of which is hereby expressly incorporated by reference.

### BACKGROUND

### Technical Field

The present disclosure relates generally to the field of computer vision and predictive modeling. More specifically, the present disclosure relates to computer vision systems and methods for determining roof age and remaining life.

### Related Art

In the insurance and risk analytics fields, the ability to determine the condition of insured objects/properties as well as to predict the useful lifespan of such products, is of significant importance. Such ability is particularly useful and important when attempting to determine the condition of the roof of an insured structure (e.g., house, building, etc.), as well as how much useful life remains for the roof. It is difficult to obtain roof information from private and public data sources/records. Additionally, roof age data only indicates the normal age of a roof, but such data does not consider critical factors such as the degradation of the material of a particular roof, the quality of such material, whether the roof is properly vented, and exposure of the roof to sunlight and other weather elements. Because of this, roof age, alone, is not a fully accurate predictor of the vulnerability of the roof against weather events, or how soon a roof may require replacement in order to remediate such vulnerabilities.

In today's world of computer vision, machine learning, and artificial intelligence technologies, it would be highly beneficial to leverage such technologies to automatically determine, from digital data sources such as aerial imagery and public/private roof data, in order to rapidly and accurately determine the age of a roof as well as predict its useful life. Accordingly which would be desirable are computer vision systems and methods for determining roof age and remaining life which address the foregoing, and other, needs.

### SUMMARY

The present disclosure relates to computer vision systems and methods for determining roof age and remaining life. The system processes newer and older images of an area of interest that includes a structure having a roof using computer vision to detect changes in roof conditions over time, and calculates a ground truth model of roof age and roof condition based on the detected changes. An initial linear regression model is calculated by the system, and noise is filtered from the model. A final linear regression model is then calculated by the system and validated. Using the final linear regression model, the system determines an age of the roof in the area of interest as well as the remaining life of the roof. The age and the remaining life can be displayed to the user in a graphical interface screen superimposed over an aerial image of the roof and/or of the area of interest.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating processing steps carried out by the processor and/or end-user computing device of FIG. 1;

FIGS. 3-4 are graphs illustrating linear regression modeling (LRM) processes carried out by the system of present disclosure in order to determine roof ages and roof conditions; and

FIG. 5 is a graph illustrating a roof age model in accordance with the present disclosure;

FIG. 6 is a diagram illustrating calculation of a remaining life of a roof in accordance with the present disclosure;

FIG. 7 illustrates a user interface screen output generated by the system of the present disclosure and indicating roof ages;

FIG. 8 illustrates a user interface screen output generated by the system of the present disclosure and indicating the remaining life of roofs by level of risk; and

FIG. 9 is a diagram illustrating model improvements over time by the system of the present disclosure.

### DETAILED DESCRIPTION

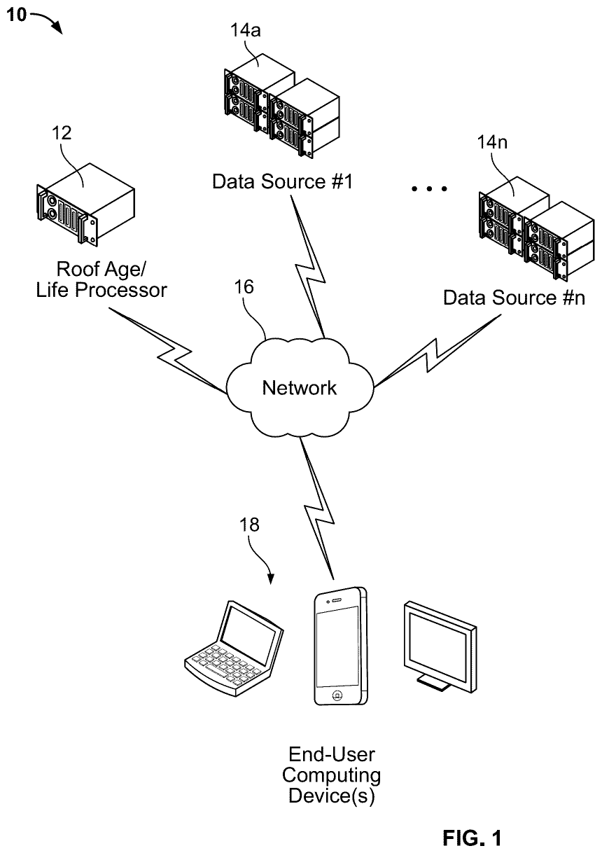

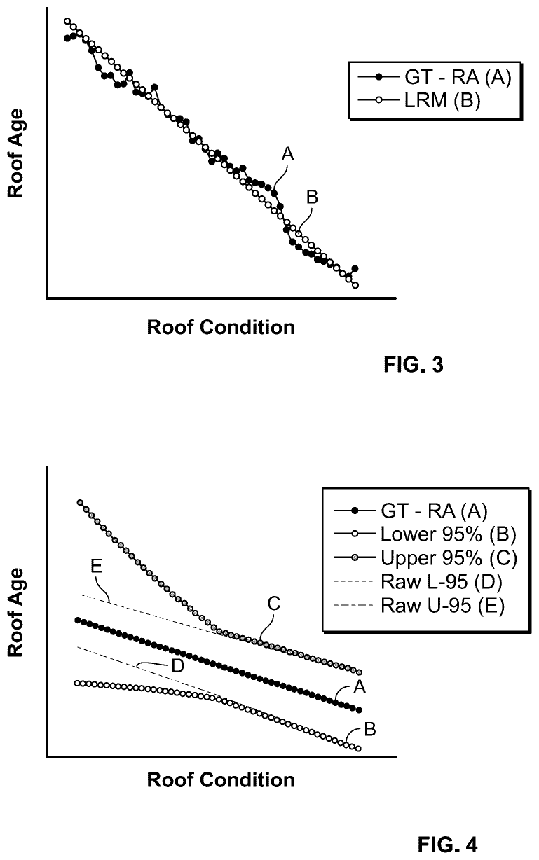

The present disclosure relates to computer vision systems and methods for determining roof age and remaining life, as discussed in detail below in connection with FIGS. 1-9.

FIG. 1 is a diagram illustrating the system of the present disclosure, indicated generally at 10. The system 10 includes a processor 12 which is programmed in accordance with the present disclosure to determine the age of a roof from digital data sources (e.g., aerial imagery, public data sources, private data sources, etc.) and to predict the remaining life of a roof using computer vision and regression modeling techniques. The processor 12 is in communication with one or more data source computer systems 14a-14n, which supply the digital data sources processed by the processor 12. The data stored by and sourced from the one or more data source computer systems 14a-14n include, but is not limited to, aerial imagery (stored in an aerial imagery database), public roof data (e.g., from a public data source such as a municipality, government data source, etc.), and private roof data (e.g., information stored in an insurer's database system, an adjuster's database system, etc.). The processor 12 and the computer systems 14a-14n could communicate via a network 16 which could include, but is not limited to, a local area network, a wide area network, an intranet, the Internet, a cellular data communications network, or any other type of network.

Additionally, the processor 12 could communicate with one or more end-user computing devices 18 which can allow a user to query for roof age and remaining life information for a particular property or structure of interest (e.g., by specifying an address or by selecting a property or region of interest in a graphical user interface of the devices 18) and to review the results of processing by the processor 12 (e.g., the calculated roof age and remaining life of the roof). Still further, it is noted that the functions performed by the processor 12 could also be performed by the end-user computing device 18, such that the device 18 communicates directly with the data source computer systems 14a-14n and is programmed in accordance with the present disclosure. The processor 12 could be any suitable computing platform capable of being programmed in accordance with the present disclosure and includes, but is not limited to, a personal computer, a server, a cloud computing device, a cloud computing platform, or any other suitable computing device/platform. The end-user device 18 could include a personal computer, a tablet computer, a smart telephone, a laptop computer, or any other suitable computing device. The processor 12 and/or end-user device 18 could be programmed in accordance with the present disclosure using and suitable low- or high-level programming language, such as C, C++, C#, Java, Javascript, Python, or any other suitable language. Additionally, the processes disclosed herein could be coded and stored as computer-readable instructions stored in one or more non-transitory, computer-readable media in communication with or forming part of the processor 12 and/or device 18, including, but not limited to, disk, memory (e.g., random-access memory, read-only memory, non-volatile memory, flash memory, etc.), field-programmable gate array (FPGA), etc., which are executed by a processor (e.g., microprocessor, microcontroller, etc.) of the processor 12 and/or device 18.

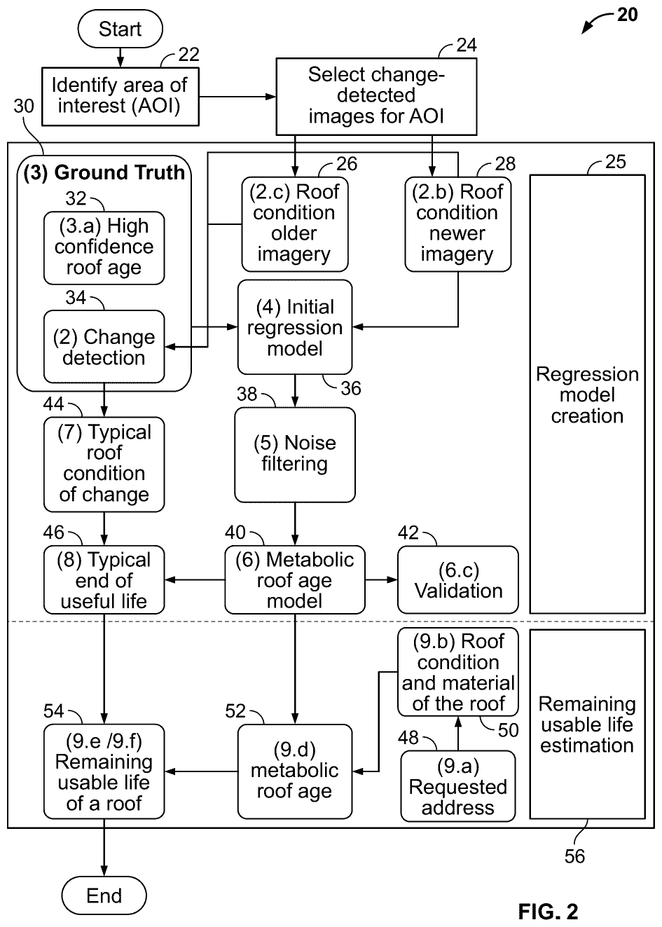

FIG. 2 is a flowchart illustrating processing steps, indicated generally at 20, carried out by the processor 12 or end-user computing device 18 of FIG. 1. Broadly speaking, the processing steps of FIG. 2 can be broken into a regression model creation phase 25, and a remaining life estimation phase 56. More specifically, beginning in step 22, the system identifies an area of interest (AOI). The AOI can be any region that encompasses buildings that are under similar weather, socio-economic, or regulatory conditions. The AOI can be identified (e.g., using a user interface of the device 18) by boundaries such as zip code, a county name, a National Oceanographic and Atmospheric Administration (NOAA) climate division, a state, etc. The AOI can be pre-defined by a user of the system (e.g., a product or project manager, a stakeholder, a customer, etc.) and/or it can be the result of an artificial intelligence (AI) model that regionalizes a territory based on, for example, climate, socio-economic, and/or geographical factors.

In step 24, the system selects and retrieves one or more change-detected images for the selected/identified AOI, e.g., from one or more of the data source computers 14a-14n. By “change-detected images,” it is meant images that have been processed by a computer system to identify one or more features associated with a structure depicted in the image and associated data, such as, but not limited to, percentage of roof discoloration, percentage of missing material, structural damage percentage, percentage of roof covered by a tarp, percentage of roof debris, percentage of roof that may be anomalous, percentage of patched or repaired roof, etc. Also, such roof information could be scored (e.g., expressed in a scale from 1.00 to 5.00, with 5 being the best condition), and/or a computer vision neural network can be trained to detect the roof material. An example of a suitable system for detecting roof conditions and associated data (e.g., scores and/or percentages) is set forth in published U.S. Patent Application Publication No. US 2022/0215654 which is expressly incorporated herein by reference. There can be multiple collections (and associated ages) of aerial images available in the AOI, and in step 24, two collections of images (newer images and older images) can be selected by the system (each collection of which is change-detected).

In step 26, the system computes the roof condition and roof materials for all roofs within the AOI that correspond to older images (e.g., all images having a pre-defined date, or earlier date). In step 28, the system computes the roof condition and roof material for all roofs within the AOI that correspond to newer images (e.g., all images having a pre-defined date, or later date). Then, in step 34, for each building within the AOI, the system calculates the difference between the newer roof condition and the older roof condition, and labels as change detected any roof that meets two criteria: the newer roof condition is greater than a pre-defined threshold A, and the calculated difference between the newer roof condition and the older roof condition is greater than a pre-defined threshold B. Additionally, in step 34, for those roofs labeled as “change detected,” the roof age for the roof is set as the average age of the newer image and the older image dates.

Step 34 is the first step of the ground truth determination process 30. The second step is step 32, wherein the system communicates with a database of roof ages (which could be from public and/or private data sources and could be stored in one or more of the data source computers 14a-14n) and filters any records that are within the AOI and equal to or above a defined roof age confidence threshold C. Then, the ground truth dataset is determined by the system as the result of aggregating the high-confidence roof ages and a roof age calculated using computer vision change detection (e.g., the roof age calculated in step 34).

Next, in step 36, the system calculates an initial linear regression model (LRM) in the form of Y=ax+B, where X is the roof condition (determined in step 28) of the newer imagery grouped by intervals of a defined length D and Y is the average of the ground truth roof age of the roof condition interval (calculated in Step 32). Table 1, below, sets forth an example of the model values that could be calculated in step 36:

TABLE 1

| Roof Condition interval | Average Ground Truth Roof Age |
|---|---|
| . . . | |
| 2.75 | 17.6 |
| 3.00 | 15.2 |
| . . . | |
| 5.00 | 1.1 |

Additionally, in step 36, the system estimates the accuracy and reliability of the LRM using a variety of statistical measures including, but not limited to, mean squared residual, R2 value, F-test, etc. If the LRM is not accurate or reliable enough, then the system can gather additional ground truth data either by increasing the extension of the AOI or by lowering the threshold C of the high confidence RA. Additionally, since each roof material wears differently, the LRM is preferably computed for each roof material such as, but not limited to, shingle, tile, or metal. An example of the initial LRM computed in step 36 is shown in FIG. 4, wherein the LRM of roof age and roof condition is plotted against the ground truth roof age (GT-RA).

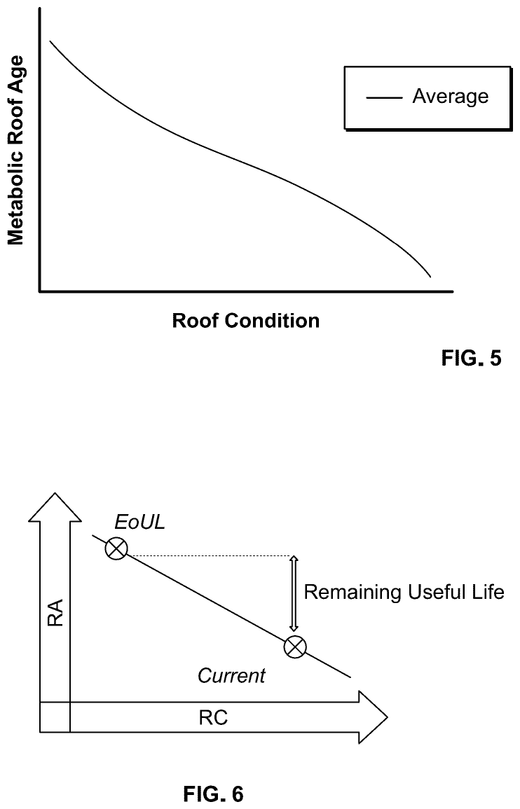

In step 38, the system performs noise filtering of the LRM. Specifically, in order to reduce the effect of an in accurate ground truth roof age, the system computes the LRM at the 95th confidence level. Then, any ground truth roof age above or below the expected roof age within the 95th confidence level is labeled as an outlier. Next, any outliers are removed from the ground truth roof age prior to calculating a final LRM, and the LRM at the 95% confidence level can be modified to permit additional variability in the lower roof condition values. An example of this noise filtering step is shown in FIG. 5, wherein the LRM, lower upper 95% confidence level, upper 95% confidence level, and raw values are plotted.

In step 40, a roof age model (e.g., a final LRM) is calculated by the system. Specifically, the final LRM is calculated in the cubic form of Y=a₁*X³+a₂*X²+a₃*x+b, where: X is the roof condition of the newer imagery, grouped by intervals of defined length D; Y is the average of the ground truth roof age, filtered of outliers, of the roof condition of the interval; and 80% of the records are used for calculating the parameters of the LRM, while the remaining 20% are reserved for validation. The cubic form of a LRM is selected to model three different possible stages of roof deterioration. For example, in the case of roof material shingles, such stages could be: (1) initial slow deterioration; (2) intermediate accelerated deterioration; and (3) final decelerated deterioration.

Further, in step 40, the system estimates the accuracy and reliability of the LRM using a variety of statistical measurements such as mean squared residual, R2 value, F-test, etc. In step 42, the coherence of the validation set versus the LRM is estimated by the system, also using the aforementioned statistical measurements. The validation set is formed by 20% of the ground truth roof age data that has not been used for calculating the LRM. Since each material wears differently, the LRM should be independently computed for each roof material, such as shingle, tile, metal, etc. The final LRM is referred to as the roof age model of the given AOI and roof material. The roof age of a particular roof is the result of solving the model for a particular roof condition, AOI, and roof material. An example of the final LRM (the roof age model is illustrated in FIG. 5.

In step 44, the system determines a typical roof condition of change. In this step, the system collects the roof condition prior to the change dataset as the roof condition of the older images for which a roof change was detected. Then, the typical roof condition of change is defined as a measure that describes the central tendency of the roof condition prior to the change dataset, such as the median or the arithmetic mean. Next, in step 46, the system calculates a typical end of remaining life for the roof. Specifically, the typical end of remaining life is defined as the roof age of the typical roof condition of change of a given AOI and roof material. Because each roof material wears differently, the typical end of remaining life should be computed for each roof material, such as shingle, tile, metal, etc.

The system next calculates a remaining life of a roof. In step 48, given an address or a geolocation, the system finds the most recent image available at that location. Then, in step 50, the system processes the image with a computer vision neural network to compute the roof condition and the roof material of the requested roof. Additionally, the system finds the correspondence roof age model and the typical end of remaining life for the requested location and roof material. Then, in step 52, the system calculates the roof age of the requested roof.

Finally, in step 54, the system calculates the remaining life as the difference between the typical end of remaining life and the current roof age of the requested roof. Also, the remaining life is classified in a level of risk or vulnerability. Table 2, below, illustrates some sample levels of risk:

TABLE 2

| Level of Risk | Remaining Life range | |
|---|---|---|
| A | >10 | years |
| B | 6 to 10 | years |
| C | 2 to 5 | years |
| D | −1 to 1 | year |
| E | <−1 | year |

The calculations performed in step 54 are illustrated in FIG. 6, wherein the end of remaining life (EoUL) and the current life are plotted along the final LRM, and the remaining life is the difference between the plotted values.

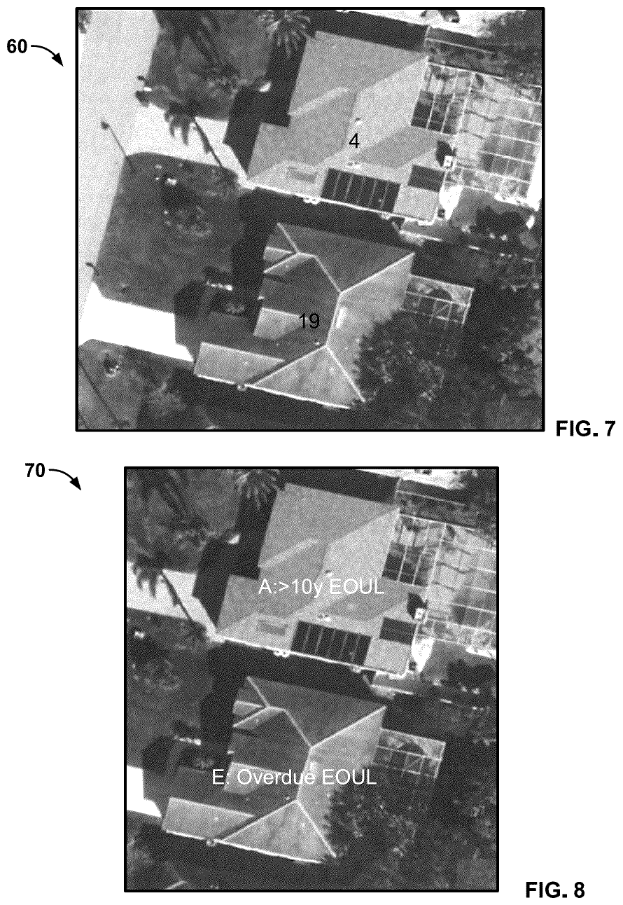

FIG. 7 illustrates a user interface screen output generated by the system of the present disclosure and indicating roof ages. As can be seen, the roof ages are the numeric values 4 and 19 and are shown superimposed above the respective roofs shown in the image (which corresponds to the AOI).

FIG. 8 illustrates a user interface screen output generated by the system of the present disclosure and indicating the remaining life of roofs by level of risk. As can be seen, the risk level A indicates that there is greater than 10 years before the EoUL of the first roof at the top of the image, whereas the roof at the bottom image has risk level E because the roof is past its EoUL.

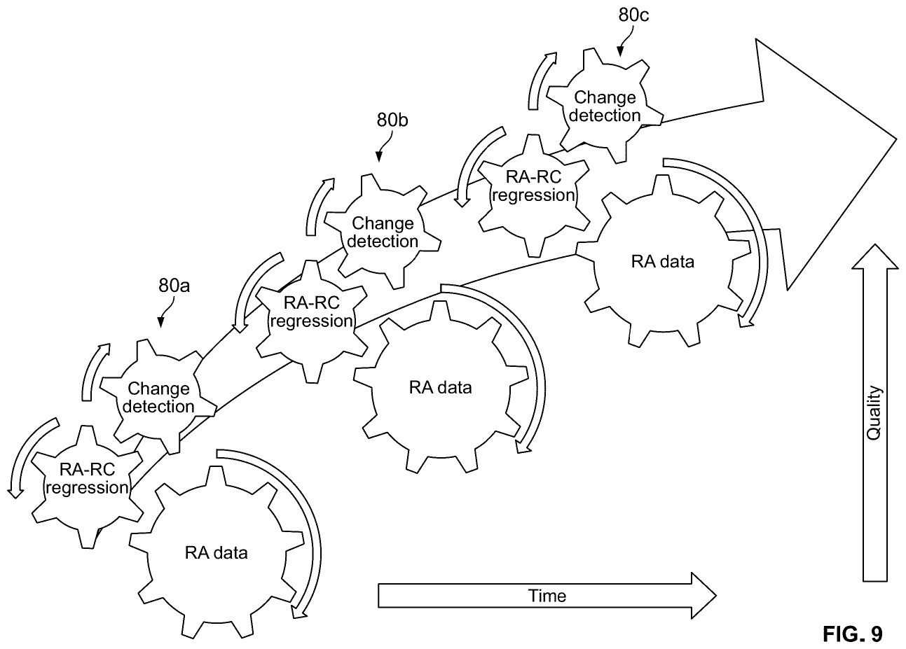

FIG. 9 is a diagram illustrating model improvements over time by the system of the present disclosure. Successive versions of the system components (including change detection, roof age and roof condition regression, and roof age data) are illustrated as elements 80a-80c, such that version 80b has a higher quality over time than version 80a and version 80c has a higher quality over time than version 80b. Essentially, the roof age is continuously updated by the system and calibrated at any of the following events: new imagery of an AOI (partial or entire extension of the AOI) is received by the system (which implies that the updated roof condition roof material data is computed through computer vision, and that new change detection events are recorded by comparing the new imagery versus the prior set); new high confidence roof age data compiled from public and private data sources; or customer or third party feedback or reporting with an indication of the correct age of a roof or a list of roofs.

Additionally, the frequency of the updates or calibrations can match the product and system architecture needs. Updates/calibrations can occur in real time when any of the aforementioned events happen, or can be scheduled to occur at a certain cadence (e.g., daily, weekly, monthly, or quarterly). In addition to the updates, the system can be updated under one or more of the following circumstances: modification of the underlying modeling algorithms (e.g., use of a non-linear regression model, a generalized linear model, or an artificial intelligence model); or incorporation of additional variables to the model, such as weather data, tree coverage, etc. Because the system is based on the use of ground truth data, the system's accuracy and performance can improve over time as new data is collected and incorporated into the system.

While the system of the present disclosure has been described in connection with determining the age and remaining life of a roof, it is to be understood that the systems and methods disclosed herein could be applied to determine the age and remaining life of a wide variety of materials and structures, such as road structures/materials (e.g., asphalt, concrete, etc.), building structures/materials (e.g., siding (e.g., vinyl siding), façades, façade materials (e.g., flashing, coping, etc.), walls, windows, glass, etc.), and other building components/structures/materials.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A computer vision system for determining an age or a remaining life of a roof of a structure, comprising:
a processor in communication with at least one data source and an end-user device, the processor programmed to:
receive first and second images from the at least one data source depicting an area of interest of the roof;
process the first and second images to detect at least one change in a condition of the roof over time;
calculate a ground truth model of a roof age and a roof condition based on the at least one change;
calculate an initial linear regression model using the ground truth model;
filter noise from the initial linear regression model;
calculate and validate a final linear regression model from the filtered initial regression model; and
determine an age or a remaining life of the roof of the structure using the final linear regression model.

2. The system of claim 1, wherein the processor is programmed to display the age or the remaining life of the roof on a graphical interface screen superimposed over an aerial image of the roof or the area of interest.

3. The system of claim 1, wherein an area of interest is identified using a boundary including at least one of a zip code, a county name, a climate division, or a state.

4. The system of claim 1, wherein the at least one change in the condition of the roof includes one or more off roof discoloration, percentage of missing material, structural damage percentage, percentage of the roof covered by a tarp, percentage of roof debris, percentage of the roof that is anomalous, or percentage of patched or repaired roof sections.

5. The system of claim 1, wherein the processor detects the at least one change using computer vision neural network.

6. The system of claim 1, wherein the ground truth model is determined at least in party by aggregating high-confidence roof ages and calculating the roof age using the computer vision change detection.

7. The system of claim 1, wherein the noise is filtered from the initial regression model by removing outliers from the ground truth model that are above or below a selected confidence level.

8. The system of claim 1, wherein the final linear regression model models at least one stage of roof deterioration including initial slow deterioration, intermediate accelerated deterioration, and final decelerated deterioration.

9. The system of claim 1, wherein the remaining life of the roof is expressed as a level of risk corresponding to a range of years of life remaining for the roof.

10. The system of claim 1, wherein the processor is programmed to calibrate modeling of the age of the roof or the remaining life of the roof using at least one of updated imagery, updated roof age data, or user feedback.

11. A computer vision method for determining an age or a remaining life of a roof of a structure, comprising:
receiving at a processor first and second images from at least one data source depicting an area of interest of the roof;
processing the first and second images to detect at least one change in a condition of the roof over time;
calculating a ground truth model of a roof age and a roof condition based on the at least one change;
calculating an initial linear regression model using the ground truth model;
filtering noise from the initial linear regression model;
calculating and validating a final linear regression model from the filtered initial regression model; and
determining an age or a remaining life of the roof of the structure using the final linear regression model.

12. The method of claim 11, further comprising displaying the age or the remaining life of the roof on a graphical interface screen superimposed over an aerial image of the roof or the area of interest.

13. The method of claim 11, further comprising identifying an area of interest using a boundary including at least one of a zip code, a county name, a climate division, or a state.

14. The method of claim 11, wherein the at least one change in the condition of the roof includes one or more off roof discoloration, percentage of missing material, structural damage percentage, percentage of the roof covered by a tarp, percentage of roof debris, percentage of the roof that is anomalous, or percentage of patched or repaired roof sections.

15. The method of claim 11, further comprising detecting the at least one change using computer vision neural network.

16. The method of claim 11, wherein the ground truth model is determined at least in party by aggregating high-confidence roof ages and calculating the roof age using the computer vision change detection.

17. The method of claim 11, wherein the noise is filtered from the initial regression model by removing outliers from the ground truth model that are above or below a selected confidence level.

18. The method of claim 11, wherein the final linear regression model models at least one stage of roof deterioration including initial slow deterioration, intermediate accelerated deterioration, and final decelerated deterioration.

19. The method of claim 11, wherein the remaining life of the roof is expressed as a level of risk corresponding to a range of years of life remaining for the roof.

20. The method of claim 11, further comprising calibrating modeling of the age of the roof or the remaining life of the roof using at least one of updated imagery, updated roof age data, or user feedback.
